(19) United States
(12) Patent Application Publication
(10) Pub. No.: US 2013/0013401 A1
(43) Pub. Date: Jan. 10, 2013

(54) SYSTEM AND METHOD FOR PROVIDING DOCUMENT LINK SERVICE AND LINKABLE ADVERTISEMENT

(75) Inventor: DongWook KIM, Seongnam-si (KR)

(73) Assignee: NHN CORPORATION, Seongnam-si (KR)

(21) Appl. No.: 13/537,444

(22) Filed: Jun. 29, 2012

(30) Foreign Application Priority Data
Jul. 5, 2011 (KR) 10-2011-0066408

(51) Int. Cl. G06Q 30/02

(52) U.S. Cl. 705/14.49

(57) ABSTRACT

Provided is a cloud-based document linking system and a method that uses a processor to provide a method for providing an advertisement and a service linkable with a document stored on a cloud-based cross-clipboard. The cloud-based document link system includes a storage unit to store, on a cross-clipboard, at least one first document associated with a first service provided through a first device if the at least one first document is requested to be copied onto the cross-clipboard, an identification unit to identify at least one second service linkable with the at least one first document stored on the cross-clipboard, a selector to select at least one advertisement associated with each first document stored on the cross-clipboard, and a providing unit to provide a list of the first document and a list of the corresponding at least one second service with the at least one selected advertisement.

### CROSS-REFERENCE TO RELATED APPLICATION

This application claims priority from and the benefit of Korean Patent Application No. 10-2011-0066408, filed on Jul. 5, 2011, which is hereby incorporated by reference for all purposes as if fully set forth herein.

### BACKGROUND

1. Field

Exemplary embodiments of the present invention relate to a document linking service.

2. Discussion of the Background

Developments in communications technology may entail various types of services related to providing a document on the Internet (e.g., web document). A lifecycle for a document may include an expression step of searching for a document, a selection step of selecting a document from a search results list, and a use step of using or viewing a document. The use step may have a characteristic in that use of a document may not be terminated while the expression step and the selection step may be repeatedly performed, and the use of the document may not be continuously performed. More specifically, a search result may be utilized without interruption.

A data type in which a document may be used without interruption may include, without limitation, a prepare and execute type, a keep doing type, and gather and review type. The prepare and execute type may correspond to a case where an intent to use a document may be expressed in a personal computer (PC) or a similar device, and the document may be used in a destination terminal, which may include a smart television, another PC, a tablet computer, a mobile terminal and the like. The keep doing type may correspond to a case where a document may be used in a PC or a similar device, and use of the document may be expanded in a destination terminal. The gather and review type may correspond to a case where a clue or a hint for a document may be collected in a mobile document, and the document may be directly used in a PC in which utilization of the document may be more convenient.

Internet services may involve a difference in service (e.g., different services, web documents, or capabilities may be provided to different devices), a difference in time (e.g., services may be repeated in separate devices to receive similar or same information on different devices), and a difference in devices while providing a document. More specifically, Internet services may provide different capabilities and operations related to a web document, which may be provided on different devices at different times. For example, without a search process being repeated, music searched for on a PC may not be listened to via a phone or a television (TV). Similarly, without performing a repeated search process, a product searched for in a mobile phone may not be purchased via a PC. Rather, if a search is begun on a first device, a same or similar search may be repeated on a second device before a document found on the first device may be used in the second device.

To handle a difference in devices, the conventional technology may provide an integrated user environment, thereby providing a cloud service to another terminal having the same user environment, in addition to providing the cloud service to an existing terminal. However, the difference in service and the difference in time may not be addressed for Internet services.

For example, if a first device uses a first Internet browser to find a document, a second device using a second Internet browser may not use the document. Further, if a first device searches to find a document to use (e.g., a movie review, a book review, a web map, and the like), and seeks to use the same document on a second device, the second device may search for the respective document again on the second device to use. More specifically, uninterrupted use of a document may be limited in a conventional cloud service due to the difference in service, and the difference in time.

The above information disclosed in this Background section is provided for enhancement of understanding of the background of the invention and therefore it may contain information that does not form any part of the prior art nor what the prior art may suggest to a person of ordinary skill in the art.

### SUMMARY

Exemplary embodiments of the present invention provide a document link system and method for linking documents using a cloud infrastructure.

Additional features of the invention will be set forth in the description which follows, and in part will be apparent from the description, or may be learned by practice of the invention.

An exemplary embodiment of the present invention provides a cloud-based document linking system, including a storage unit configured to store, on a cross-clipboard, at least one first document associated with a first service that is provided through a first device if the at least one first document is requested to be copied onto the cross-clipboard, an identification unit configured to identify at least one second service linkable with each first document stored on the cross-clipboard, a selector configured to select at least one advertisement associated with each first document stored on the cross-clipboard, and a providing unit configured to provide, a list of each first document, and a list of the corresponding at least one second service along with the at least one selected advertisement if access to the cross-clipboard is requested through a second device.

An exemplary embodiment of the present invention provides a method that uses a processor to provide a cloud-based document link, the method including storing, on a cross-clipboard, at least one first document associated with a first service that is provided through a first device if the at least one first document is requested to be copied onto the cross-clipboard, identifying, using the processor, at least one second service linkable with each first document stored on the cross-clipboard, selecting at least one advertisement associated with each first document stored on the cross-clipboard, and providing, for a second device, a list of each first document, and a list of the corresponding at least one second service along with the at least one selected advertisement if access to the cross-clipboard is requested through the second device.

An exemplary embodiment of the present invention provide a non-transitory computer-readable recording medium including an executable program, which when executed perform a method for controlling a cloud-based document link, the method including storing, on a cross-clipboard, at least one first document associated with a first service provided through a first device if the first document is requested to be copied onto the cross-clipboard; identifying at least one second service linkable with each first document stored on the cross-clipboard; selecting at least one advertisement associated with each first document stored on the cross-clipboard; and providing, for a second device, a list of each first document, and a list of the corresponding at least one second service along with the at least one advertisement if access to the cross-clipboard is requested through the second device.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram illustrating a document link system that connects a service to a cloud infrastructure according to an exemplary embodiment of the present invention.

FIG. 2 is a block diagram illustrating an internal configuration of a document link system according to an exemplary embodiment of the present invention.

FIG. 3, FIG. 4, and FIG. 5 are diagrams illustrating a process of storing, on a cross-clipboard, a document utilized according to an exemplary embodiment of the present invention.

FIG. 6A, FIG. 6B, FIG. 7A, FIG. 7B, FIG. 7C, FIG. 8A, FIG. 8B, and FIG. 8C are diagrams illustrating a process of providing a service linkable to a document stored on a cross-clipboard according to an exemplary embodiment of the present invention.

FIG. 9 is a diagram illustrating a viewer screen on which content stored on a cross-clipboard may be retrieved according to an exemplary embodiment of the present invention.

FIG. 10 is a flowchart illustrating a document linking method according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. Like reference numerals in the drawings denote like elements.

It will be understood that when an element is referred to as being “connected to” another element, it can be directly connected to the other element, or intervening elements may be present. In contrast, when an element is referred to as being “directly connected to” another element, there are no intervening elements present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

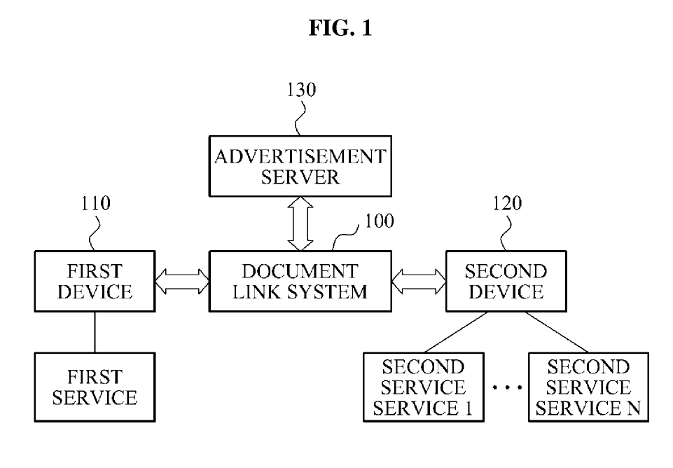

FIG. 1 is a block diagram illustrating a document link system 100 that connects a service to a cloud infrastructure according to an exemplary embodiment of the present invention.

According to exemplary embodiments of the present invention, it may be possible to provide a cloud computing environment that may share related or the same information through various communication devices, via Internet. Further, exemplary embodiments of the present invention may provide a more expansive cross-copy and paste operation with respect to a cloud infrastructure. More specifically, the cross-copy and paste operation may be similar to a clipboard function implemented in an operating system (OS) of a single stand-alone computer, but is more expansive in that cross-copy and paste operation may be used across multiple devices. That is, according to exemplary embodiments of the present invention, the cross-copy and paste operation may use a cross-clipboard function (hereinafter, referred to as a cross-clipboard) for temporarily storing or recording information between cross-platforms and cross-media. The document link system 100 may use the cross-clipboard as an application programming interface (API) to use an internal service or to provide information to a public audience.

If a user accesses an Internet service (hereinafter, referred to as a first service) through a communication device (hereinafter, referred to as a first device) 110, uses or views a document (i.e., a web article) provided by the first service (hereinafter, referred to as a first document), and requests the first document be copied by using the cross-clipboard, the document link system 100 may copy at least a portion of the first document in the first service provided through the first device 110, and store the first document copied by the cross-clipboard in a cloud environment.

Further, if the first document is copied by the cross-clipboard, the document link system 100 may identify, from the copied first document, a service that may be different from the first service and linkable to the first document (hereinafter, referred to a second service). The document link system 100 may maintain a list of the identified services or the second services. Thereafter, if the user accesses the cross-clipboard at a different time or a different space through a second device 120, the document link system 100 may provide a list of the first documents stored on the cross-clipboard. Further, the document link system 100 may provide the second device 120 with a list of the second services linkable with the first document.

In an example, a cloud-based cross-clipboard may be used as a new advertisement channel since copying of a reference document onto the cross-clipboard by a user may indicate some, if not a relatively strong, interest in the corresponding information. That is, the document link system 100 may link an advertisement associated with the first document stored on the cross-clipboard in conjunction with an advertisement server 130 that may provide an advertisement service. The document link system 100 may provide an advertisement linkable with the first document in conjunction with the advertisement server 130 if the user copies the first document onto the cross-clipboard, if the user provides a viewer environment for the cross-clipboard, or if the user pastes the first document stored on the cross-clipboard in the second service.

Referring to FIG. 1, the first device 110 and the second device 120 may refer to a communication device that may access the Internet, such as a personal computer (PC), a mobile phone, a tablet computer, a laptop computer, a television (TV), and the like. Further, the second device 120 may refer to a communication terminal that is similar to or different from the first device 110. In an example, the first device 110 and the second device 120 may be considered similar if they belong to the same categorization of equipment (e.g., mobile phones, personal computers, and the like) or have similar operating systems. The first service and the second service may refer to any Internet-based service that may provide information on the Internet in various forms. Further, the second service may refer to an Internet service (e.g., a service 1, . . . , a service N of FIG. 1) that may provide information associated with the first document stored on the cross-clipboard. Also, the second service may refer to a service that is similar to or different from the first service. A document (e.g., the first document and the second document) may correspond to a piece of systematic information or content generated by a reference application program, and may refer to an object provided to a communication terminal through an Internet service via a network connection. For example, a news article accessed by a website using a PC, a search for a music file by executing a reference application using a smart phone, and a show program displayed on TV may correspond to a document.

The document link system 100 may support use of information stored on the cross-clipboard through various communication devices. Further, the document link system 100 may support a connection of the second service having a different form from the first document to connect between different services. While a conventional system may provide an m:n conversion environment between a communication device and a communication device used for information used by the user, the document link system 100 may provide a 1:m conversion environment between a communication device and a cross-clipboard by implementing the cross-clipboard operation based on a cloud environment.

Further, the document link system 100 may provide a new advertisement channel by linking an advertisement associated with the first document stored on the cross-clipboard. More specifically, the document link system 100 may use the cross-clipboard in a cloud environment to provide an asymmetric interface, and to provide an environment in which various forms of information may be used through use of a single source.

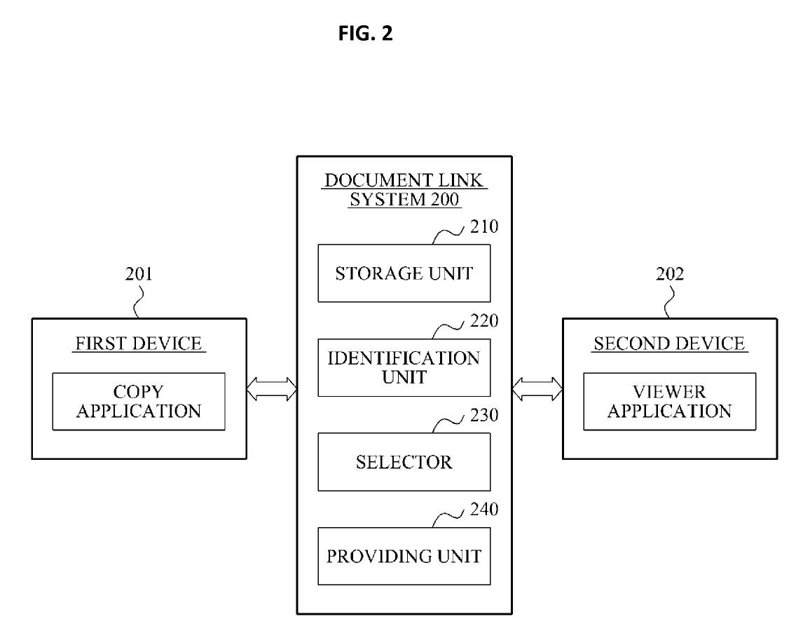

FIG. 2 is a block diagram illustrating an internal configuration of a cloud-based document link system 200 according to an exemplary embodiment of the present invention.

Referring to FIG. 2, the cloud-based document link system 200 includes a storage unit 210, an identification unit 220, a selector 230, and a providing unit 240.

The storage unit 210 may temporarily store and record a document requested to be copied. More specifically, the storage unit 210 may store, on a cross-clipboard, a first document associated with a first service that is provided through a first device 201 if the first document is requested to be copied onto the cross-clipboard. The storage unit 210 may store and maintain at least one document copied onto the cross-clipboard, which may include the first document.

For example, a copy application that may provide an interface with the storage unit 210 may be installed in the first device 201. In this example, the copy application may include a function of copying the first document in the first device 201, and transmitting the copied first document to the storage unit 210 if a request for a copy may be inputted by the user. As an example, if a user inputs a request for a copy of the first document while the user is using the first document on the first service through the first device 201 having the copy application, the copy application may perform an operation of copying the first document, which may be delivered to the storage unit 210. More specifically, through the copy application in the first device 201, the storage unit 210 may receive the first document of which a copy may be requested by the user and the first document may be copied onto the cross-clipboard to store the received first document.

As another example, if a request for a copy is inputted by the user, the copy application may not copy the first document in the first device 201, and may deliver, to the storage unit 210, the request for a copy from the user. The storage unit 210 may copy the first document provided to the first device 201 according to the request for a copy received from the copy application. More specifically, the storage unit 210 may copy the first document provided to the first device 201 at a point in time when a copy may be requested in conjunction with a database system or a server managing the first service. In an example, if storing the first document on the cross-clipboard, the storage unit 210 may store the first document in a document form (e.g., a hypertext markup language (HTML) format) provided in the first service, or may store the first document in an application format (e.g., Notepad, Microsoft (MS) Word, MS Excel, and the like) for word processing. Further, the storage unit 210 may store the first document on the cross-clipboard along with additional data, such as a document type, a source, and a storage time of the first document.

In an example, the storage time of the first document may refer to a time at which the first document is copied in the first device, or a time at which the first document is stored on the cross-clipboard. The source of the first document may include at least one of a source indicating the first device that requests a copy of the first document and a source indicating the first service that provides the first document.

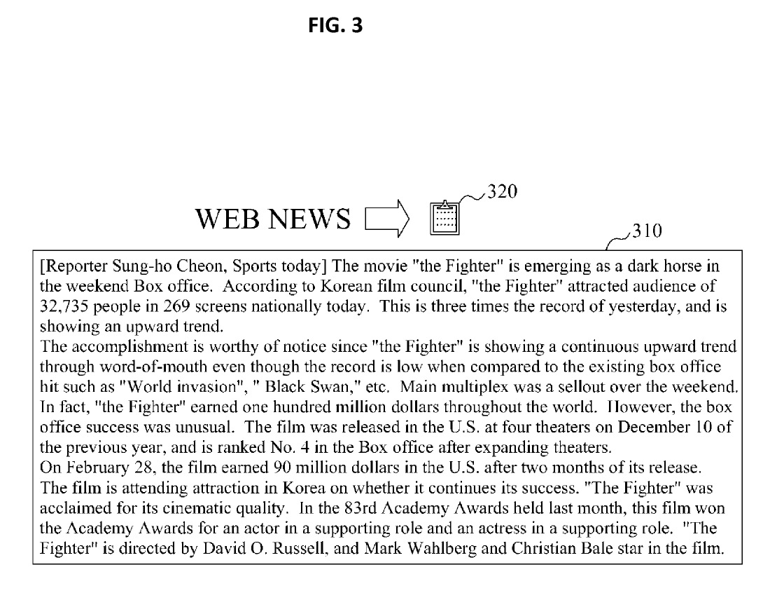

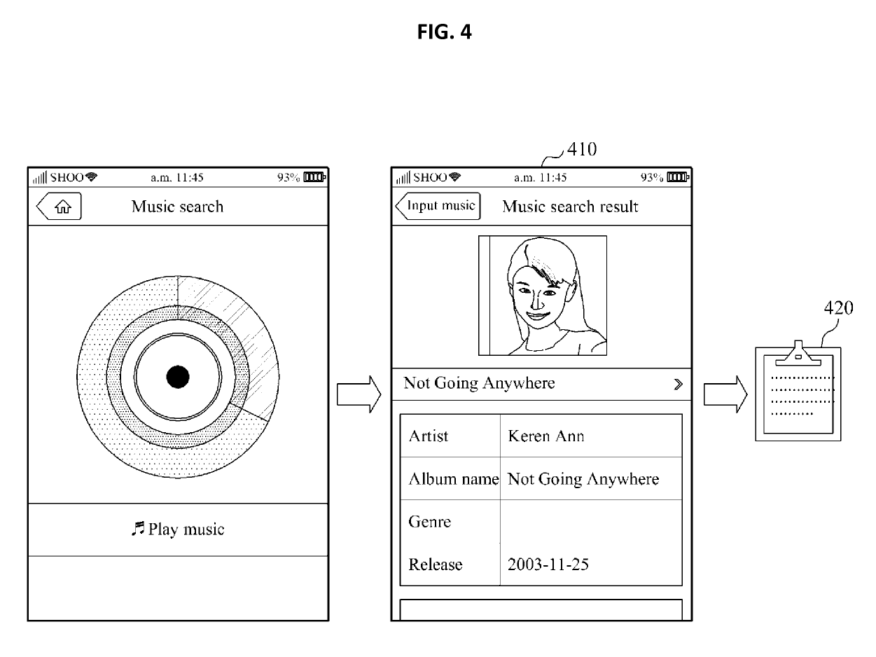

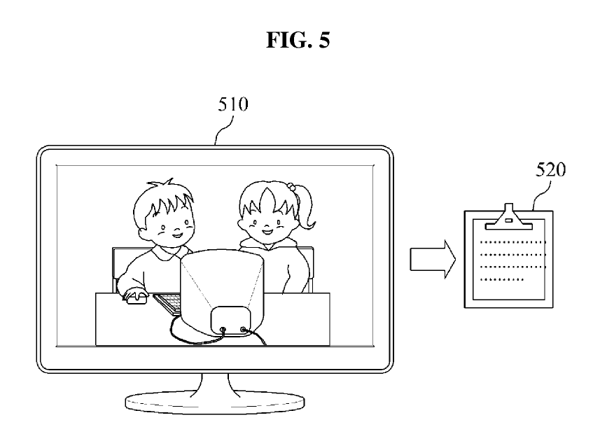

FIG. 3, FIG. 4, and FIG. 5 are diagrams illustrating a process of storing, on a cross-clipboard, a document utilized according to an exemplary embodiment of the present invention.

Referring to FIG. 3, if a user accesses a news website via a PC, and requests a copy of an article 310 provided from the news website, the storage unit 210 of FIG. 2 may store, on a cross-clipboard 320, the article 310 requested to be copied by the user. In this instance, the storage unit 210 may record ‘text’ as a type of a document stored on the cross-clipboard 320, and record, as a source of a document, at least one of a PC used to request a copy and a website providing the article 310.

Referring to FIG. 4, if a user searches for music in a mobile-dedicated application that provides a music searching service, and requests a copy of music information 410 searched for, the storage unit 210 may store, on a cross-clipboard 420, the music information 410 requested to be copied by the user. In an example, the storage unit 210 may record ‘music’ as a type of a document stored on the cross-clipboard 420, and record, as a source of a document, at least one of a mobile device that requests a copy and application information that provide the music information 410.

Referring to FIG. 5, if a user requests a copy of a program 510 the user is viewing via an Internet TV, the storage unit 210 may store, on a cross-clipboard 520, the program 510 which the user requests to be copied. In this instance, the storage unit 210 may record ‘tv on air’ as a type of a document stored on the cross-clipboard 520, and record, as a source of a document, at least one of an Internet TV terminal requesting a copy and a broadcasting company that provides the drama 510.

The identification unit 220 of FIG. 2 may identify at least one second service that may be linkable with the first document stored on the cross-clipboard. The identification unit 220 may identify the second service capable of pasting and processing the first document stored on the cross-clipboard. To this end, the identification unit 220 may include a service management module that initially receives a registration of services participating in the cross-clipboard, and manages the services. More specifically, the service management module may register and maintain services that request registration on the cross-clipboard. A service participating in the cross-clipboard may disclose an API including a function of registering, in the cloud-based document link system 200, an indication that the service may be pasted on the cross-clipboard, and a function of verifying whether a reference value is to be pasted if the reference value is stored on the cross-clipboard, and providing a result of verification to the cloud-based document link system 200, and the like.

The identification unit 220 may automatically receive verification as to whether a description, stored on the cross-clipboard is to be processed from one or more services by requesting services capable of pasting the description (i.e., service registered on the cross-clipboard). The identification unit 220 may automatically receive such verification when copying may be performed on the cross-clipboard. For example, the identification unit 220 may request, verification for whether the first document stored on the cross-clipboard is to be processed by an internal service and an external service using a service link server (not shown). The service link server may connect the internal service and the external service.

The internal service may refer to an Internet service of a corresponding company managed by a server associated with the cloud-based document link system 200. The external service may refer to an Internet service of another company not directly managed by the server associated with the cloud-based document link system 200. In response, it may be determined, based on the first document stored on the cross-clipboard, that a service participating in the cross-clipboard (i.e., the second service) may paste the first document if a document corresponding to the first document (i.e., the second document) is included in the second service, and the corresponding result may be delivered to the identification unit 220.

For example, it may be determined that the second service may paste the first document if the second document having a keyword or link information is included in the second service after extracting the keyword or the link information from the first document. In an example, the identification unit 220 may reply to the identification unit 220 with a response indicating that the second service is capable of pasting the first document, and link information of the second document corresponding to the first document. In response, the identification unit 220 may identify, as the second service linkable with the first document, services providing a response indicating that the services are capable of processing the first document stored on the cross-clipboard. The storage unit 210 may store and maintain, for the first document stored on the cross-clipboard, a list of second services identified to be linkable with the first document in the identification unit 220, and link information of the second document corresponding to the first document for one or more second services.

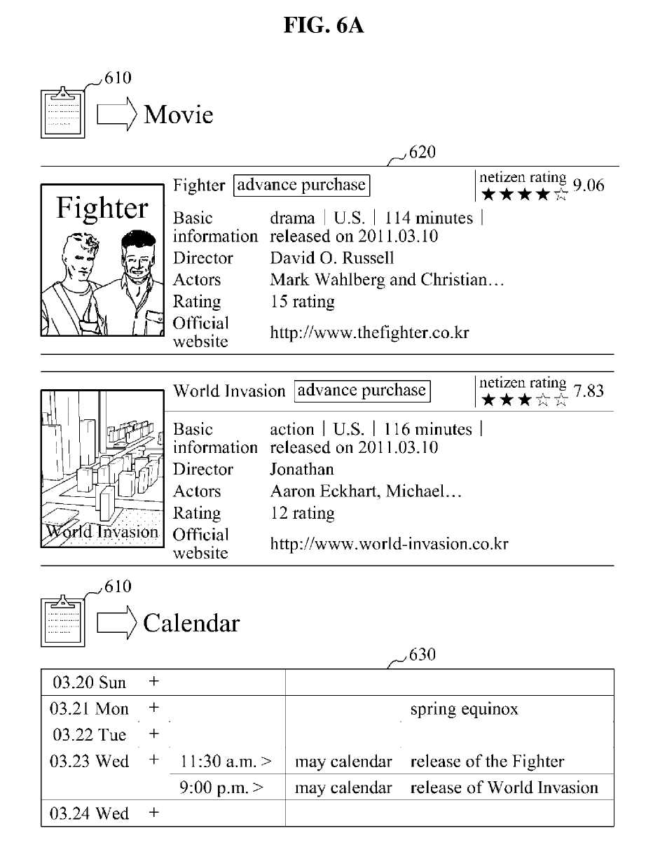

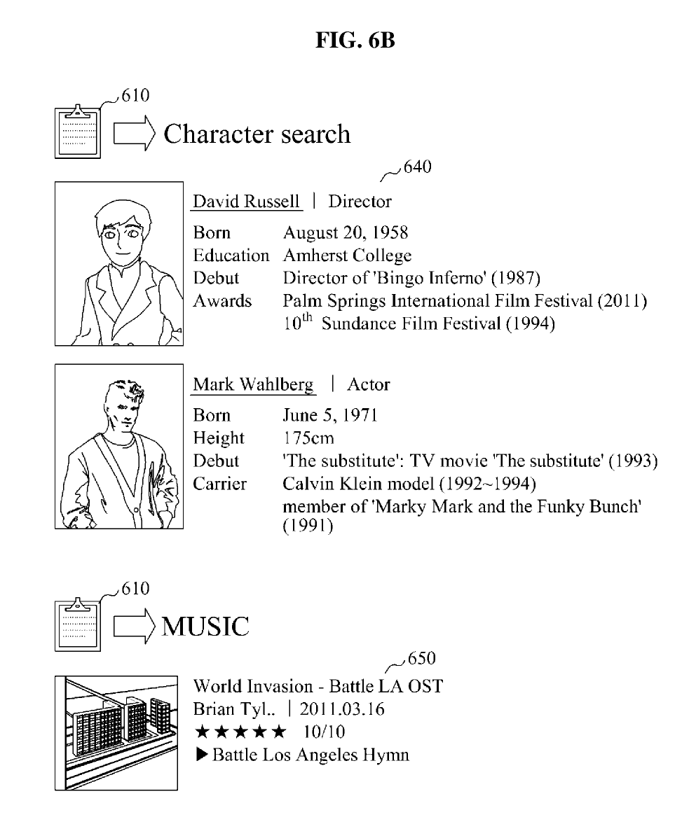

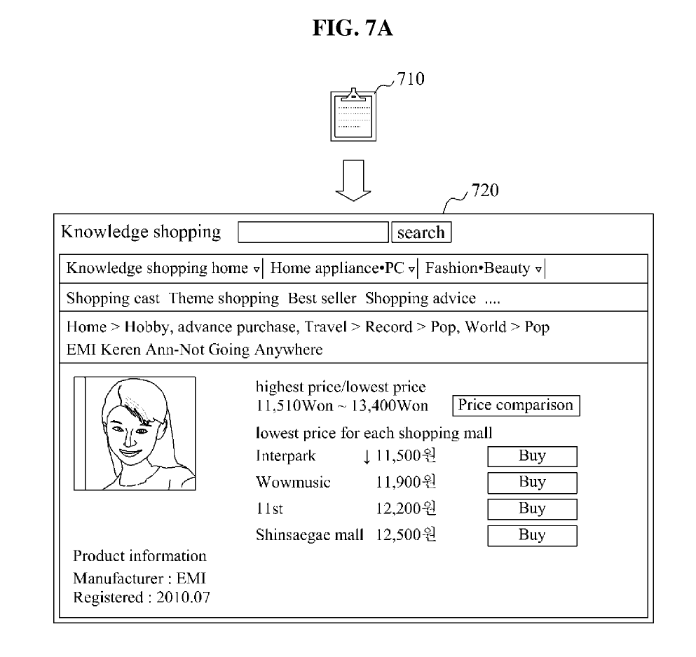

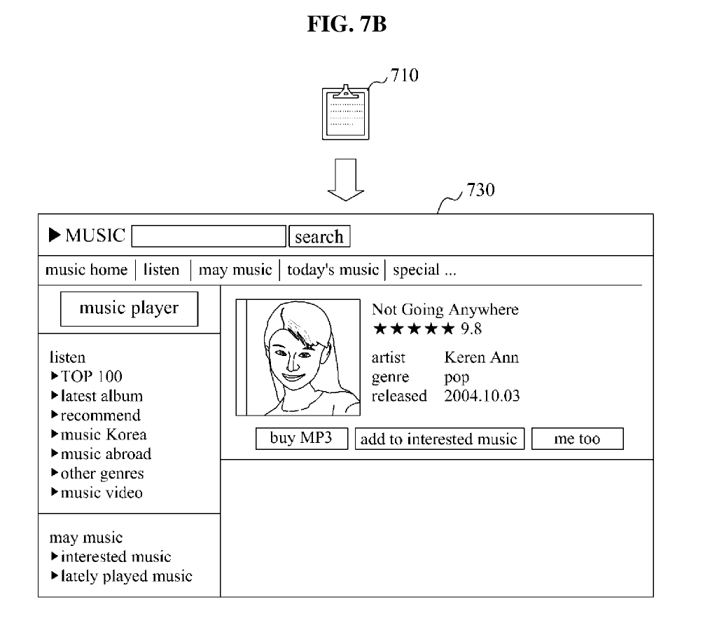

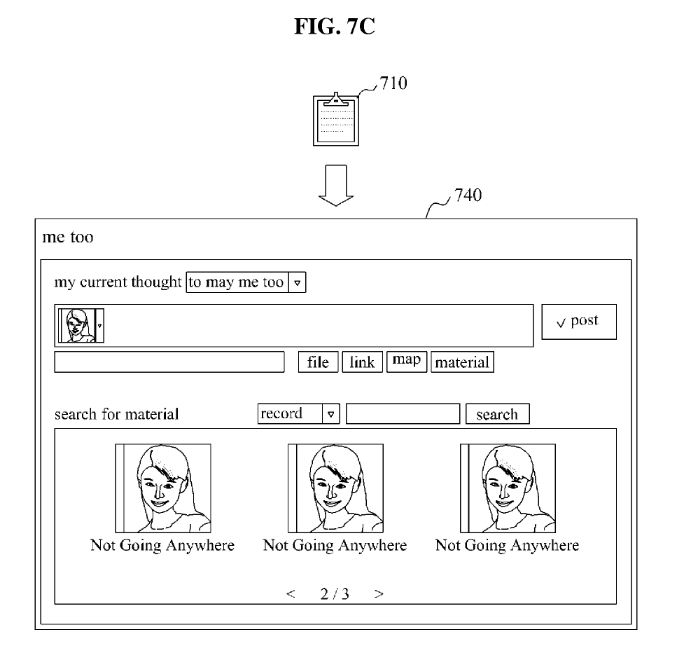

FIG. 6A, FIG. 6B, FIG. 7A, FIG. 7B, FIG. 7C, FIG. 8A, FIG. 8B, and FIG. 8C are diagrams illustrating services linkable with a document stored on the cross-clipboard.

If the first document corresponds to a document associated with a movie, the identification unit 220 may identify at least one of a service providing detailed information associated with the movie, a service providing a community associated with the movie or a user, a service for purchasing or advance purchasing of tickets for the movie, a service providing music information associated with the movie, a service managing a schedule associated with the movie, a service providing character information associated with the movie, and the like. For example, if a document stored on the cross-clipboard corresponds to an article on the Internet associated with a reference movie as illustrated in FIG. 3, or if a main keyword of the corresponding article is associated with the reference movie, the identification unit 220 may identify a movie service 620 providing detailed information of a movie included in a document 610 (e.g., a title, a genre, a director, a rating, actors, a netizen rating, a related picture, a related video, and the like), a calendar service 630 corresponding to a schedule manager that registers a schedule of a movie included in the document 610 in a user's scheduler that manages the user's schedule, a character search service 640 providing information about characters appearing in a movie included in the document 610, a music service 650 providing an original sound track (OST) of a movie included in the document 610, and the like as illustrated in FIG. 6A and FIG. 6B.

If the first document corresponds to a document associated with a song, the identification unit 220 may identify a service providing detailed information associated with the song, a service for purchasing the song or an album including the song, a service providing a community associated with the song or persons associated with the song, a service providing character information associated with the music, and the like. For example, if a document stored on the cross-clipboard is associated with a reference song as illustrated in FIG. 4, the identification unit 220 may identify at least one of a shopping service 720 providing or recommending a shopping website where the song associated with a document 710 may be purchased, a music service 730 providing detailed information of the song associated with the document 710 (e.g., a title, a genre, an artist, and the like), a community service 740 for posting a comment in which the music associated with the document 710 corresponds to a topic, and the like as illustrated in FIG. 7A, FIG. 7B, and FIG. 7C.

If the first document corresponds to a document associated with a broadcast program, the identification unit 220 may identify at least one of a service providing detailed information associated with the broadcast program, a service providing a schedule associated with the broadcast program, a service providing music information associated with the broadcast program, a service managing a schedule associated with the broadcast program, a service providing character information associated with the broadcast program, a service providing a community associated with the broadcast program or a user, and the like. For example, if a document stored on the cross-clipboard is associated with a reference broadcast program as illustrated in FIG. 5, the identification unit 220 may identify a community service 820 for posting a comment in which a broadcast program associated with a document 810 corresponds to a topic being discussed in the community service 820, a broadcast service 830 providing broadcast information of the broadcast program associated with the document 810 (e.g., a title, a broadcasting time, ratings, a management agency, a production crew, actors, and the like), a TV schedule service 840 providing schedule information of the broadcast program associated with the document 810, and the like as illustrated in FIG. 8A, FIG. 8B, and FIG. 8C.

If the first document corresponds to a document associated with a product, the identification unit 220 may identify at least one of a service providing detailed information associated with the product, a service for purchasing the product, a service for managing a schedule associated with the product, and a service providing a community associated with the product or a user.

The selector 230 may select at least one advertisement associated with the first document stored on the cross-clipboard. In this instance, the selector 230 may select an advertisement linkable with the first document in conjunction with an advertisement service providing an advertisement. Here, the advertisement may refer to an advertisement provided using the Internet as a medium, and may include a coupon advertisement into which a coupon is inserted, and the like. As a method of selecting an advertisement, a concept of contextual advertising such as, AdSense® of Google® may be applied. That is, the selector 230 may select an advertisement having a relatively high degree of association with the first document by analyzing content, context, and the like included in the first document. Here, the selector 230 may select an advertisement matching the first document using various types of information such as a text corresponding to the first document, a keyword extracted from the first document, a document type, source, storage time of the first document, and the like.

As another method for selecting an advertisement, a scheme of initially designating an object of displaying an advertisement may be applied. In response, the selector 230 may select, as an advertisement associated with the first document, an advertisement in which the first document is included in a reference advertisement display object.

For example, an object displaying an advertisement may be mapped. That is, a bank advertisement may be displayed as an object related to a news article of a financial section, a restaurant advertisement for restaurants located around Seorak Mountain may be displayed as an object on a digital map of Seorak Mountain and surrounding areas, and a theater advertisement may be displayed as an object for a news article associated with a movie. The selector 230 may select, as an advertisement associated with the first document, an advertisement in which the second service identified to be linkable with the first document in the identification unit 220 is designated as an advertisement display object. For example, if a movie service is designated as an advertisement display object related to a theater advertisement and the movie service is included in the second service identified to be linkable with the first document, the corresponding advertisement may be selected as an advertisement associated with the first document.

In another example of selecting an advertisement, the selector 230 may select, as an advertisement associated with the first document, and advertisement in which at least one of the first document stored on the cross-clipboard and the second service identified to be linkable with the first document is included in a reference advertisement display object. If at least one advertisement is selected for the first document stored on the cross-clipboard, the selector 230 may determine a representative advertisement from the at least one advertisement. In this instance, the selector 230 may randomly determine the representative advertisement from the selected advertisement, or may determine the representative advertisement according to a display order determined between advertisements (for example, a correlation order, a quality index order, and advertisement bidding price, and the like).

The providing unit 240 may provide at least one second service for the first document stored on the cross-clipboard if access to the cross-clipboard is requested through a second device 202 from the user. In this instance, the second device 202 may refer to a communication terminal that is similar to or different from the first device 201 (e.g., two PCs). In response to a user accessing the cross-clipboard through the second device 202, the providing unit 240 may initially provide, based on data stored in the storage unit 210, a list of the second services for one or more first documents, along with a list of the first document stored on the cross-clipboard. If a user selects one of the second services from the list of the second services, the providing unit 240 may provide the second device 202 with a second document provided by the selected second service. As an example, a user may request access to the cross-clipboard by accessing the providing unit 240 through the second device 202. In response, the providing unit 240 may output, on a screen, at least one of a list of the first documents, a list of the second services, and a second document provided in the second service in a view environment targeting the second device 202.

As another example, a viewer application providing an interface with the providing unit 240 may be installed in the second device 202. In this instance, the viewer application may include a function of delivering a request for access to the cross-clipboard in response to the request being input from a user to the providing unit 240, and a function of outputting, on a screen, at least one of the second document provided by the second service, the list of the second service, and the list of the first document provided by the providing unit 240 based on an interface with the user.

The providing unit 240 may link an advertisement associated with the first document related to an object of at least one of the first device 210 and the second device 202. As an example, the providing unit 240 may provide or display the corresponding advertisement for an object of the first device 201 if the first document is stored on the cross-clipboard according to a copy request from a user. The providing unit 240 may provide, as a pop-up advertisement, an advertisement associated with the first document using a pop-up window operation of the first device 201 at a point in time at which the first document requested by a user to be copied through the first device 201 is stored on the cross-clipboard. As another example, the providing unit 240 may provide or display an advertisement associated with the first document in one or more items included in a list of the first documents if displaying, to a user, the list of the first documents according to a request for access received through the second device 202. As still another example, the providing unit 240 may provide or display an advertisement associated with the first document stored on the cross-clipboard in the second service if pasting the first document. More specifically, if a user selects at least one second service in a list of second services, the selected second service may provide the second device 202 with the second document corresponding to the first document. In an example, the selector 230 may display a selected advertisement. Thus, the providing unit 240 may link an advertisement associated with the first document for at least one of a copying operation, a viewing operation, and a pasting operation of the first document.

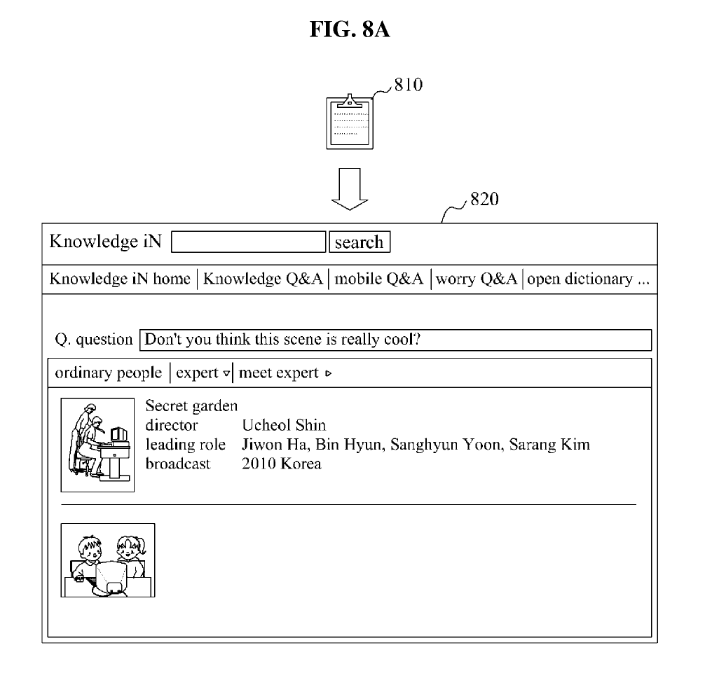

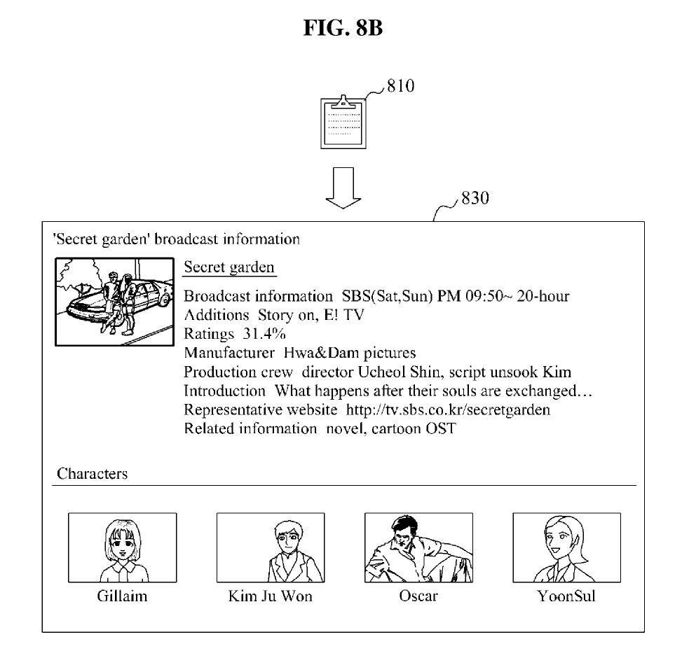

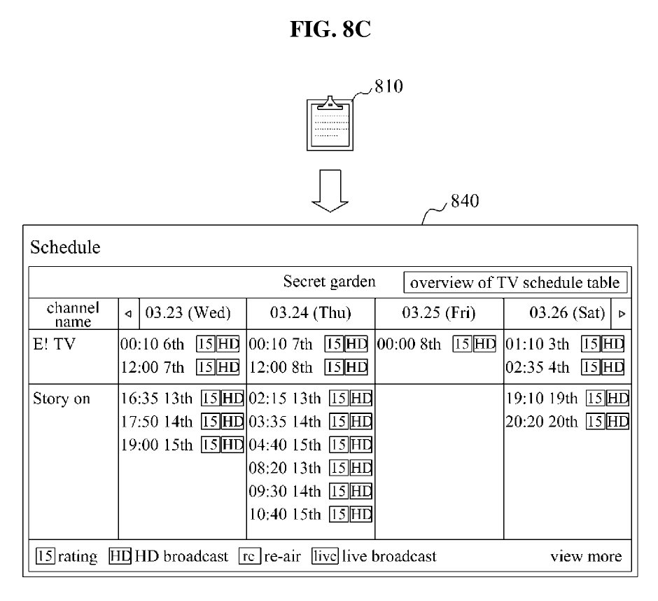

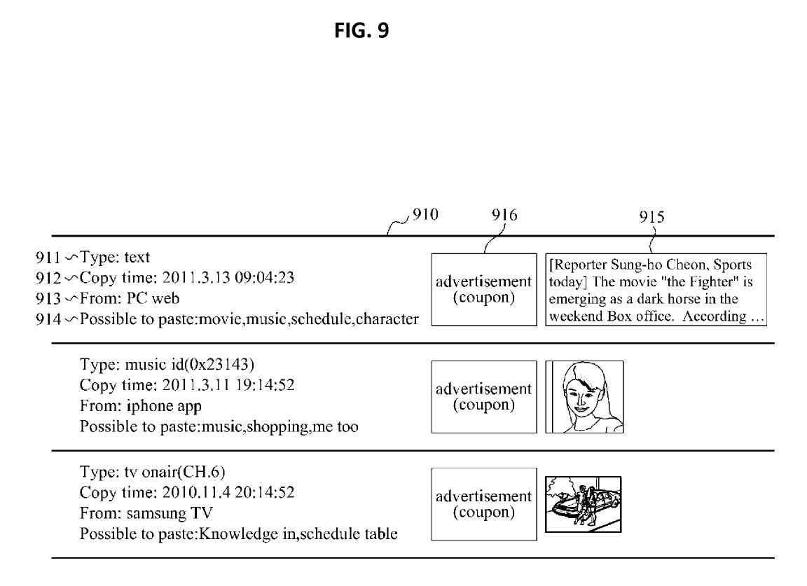

FIG. 9 is a diagram illustrating a viewer screen 910 provided to the second device 202, on which content stored on a cross-clipboard may be retrieved according to an exemplary embodiment of the present invention.

In response to a user requesting access to a cross-clipboard through the second device 202, the viewer screen 910 may be executed on the second device 202 as illustrated in FIG. 9. The first document stored on the cross-clipboard may be displayed on the viewer screen 910 by being aligned according to item types. Since at least one first document may be stored on the cross-clipboard, various schemes may be applied to an order of displaying items if displaying a list of the first documents in a viewer environment.

As an example, the providing unit 240 may align the first document stored on the cross-clipboard according to an order of a storage time included in additional data (i.e., copied time), and display the first document. As another example, the providing unit 240 may align the first document stored on the cross-clipboard in a descending or ascending order based on number of second services capable of pasting the first document, and display the first document. As still another example, the providing unit 240 may align the first document stored on the cross-clipboard according to a number of the corresponding advertisements, and provide the first document if the corresponding advertisements are included. More specifically, the providing unit 240 may align the first document stored on the cross-clipboard in a descending or ascending order based on number of advertisements selected for the first document by the selector 230. As yet another example, the providing unit 240 may align the first document stored on the cross-clipboard according to a descending or ascending order of popularity corresponding to a number of copy requests from other users, and display the first document based on a copied result by other users. As another example, the providing unit 240 may align the first document stored on the clipboard according to a document type or a source, and display the first document. The providing unit 240 may receive, from a user, an input of an item display standard for the first document stored on the cross-clipboard (e.g., an order of storage time, an order of a number of services, an order of a number of advertisements, an order of copy popularity, and the like), may align a list of the first documents according to a reference standard selected by the user or by a reference system configuration, and may display the first document.

Referring to FIG. 9, a document type 911, a storage time 912, and a source 913 corresponding to additional data associated with the first document may be displayed for one or more items displayed on the viewer screen 910. Further, a thumbnail 915 for the first document may be displayed on the viewer screen 910 so that a user may recognize the first document corresponding to one or more items. Further, a list of second services 914 linkable with the first document may be provided to one or more items displayed on the viewer screen 910. In this instance, a hyperlink for connecting with service may be activated and displayed in the list of the second service 914. The hyperlink displayed in a list of the second service 914 may be set to link information of the second document matching the first document stored for one or more second services.

Referring FIG. 9, an advertisement 916 associated with the first document may be displayed in one or more items indicating a list of the first document on the viewer screen 910. In this instance, the advertisement 916 may be displayed in a form of a graphic image or an icon to support a link with the corresponding advertisement page according to a selection by a user. More specifically, a user may search for the first document stored on the cross-clipboard on the viewer screen 910 through the second device 202, and may access an advertisement and/or the second service associated with the first document. In response to a user selecting a reference service from the list of the second services 914, the selected second service may be linked, enabling the user to utilize an associated advertisement and/or the second document provided in the second service.

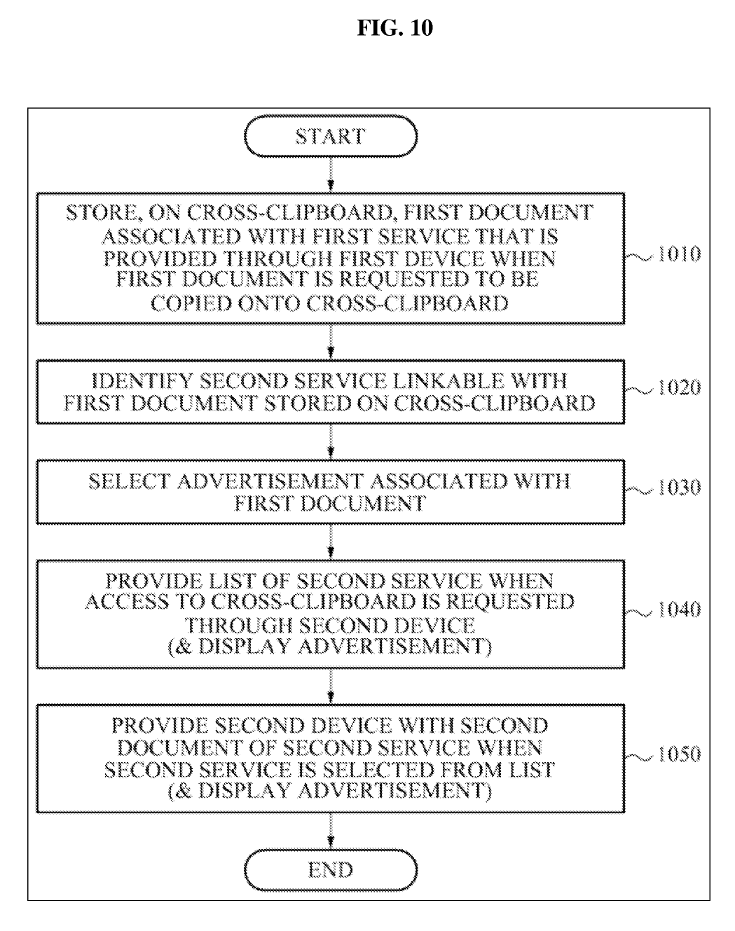

FIG. 10 is a flowchart illustrating a document link method according to an exemplary embodiment of the present invention. The document link method of FIG. 10 may be performed by the cloud-based document link system 200 of FIG. 2 and will be described as such, but the described method is not limited thereto.

In operation 1010, the cloud-based document link system 200 may store, on a cross-clipboard, a first document associated with a first service that may be provided through a first device if the first document is requested to be copied onto the cross-clipboard. In this instance, a copy application executed in conjunction with the cloud-based document link system 200 may be installed in the first device. As an example, in response to a copy request inputted by a user, the copy application may deliver the copy request from the user to the cloud-based document link system 200, and the storage unit 210 may copy the first document provided to the first device 201 in the first service at a point in time when the copy request occurs. The cloud-based document link system 200 may store additional data, such as a document type, a source, a storage time, and the like of the first document if storing the first document. In an example, the source of the first document may include at least one of a source indicating the first device requesting a copy of the first document, and a source indicating the first service providing the first document.

In operation 1020, the cloud-based document link system 200 may identify at least one second service linkable with the first document stored on the cross-clipboard. The cloud-based document link system 200 may receive verification as to whether a description, automatically stored on the cross-clipboard if a copy operation is performed on the cross-clipboard, is to be processed from one or more services by requesting services capable of pasting the description. More specifically, the cloud-based document link system 200 may receive a registration of services participating in the cross-clipboard, and request the services participating in the cross-clipboard for whether the services may paste the first document if storing the first document on the cross-clipboard. In an example, a service participating in the cross-clipboard (i.e., the second service) may determine based on the first document stored on the cross-clipboard that the service may paste the first document if the second document corresponding to the first document is included. Further, the service may deliver the corresponding result to the cloud-based document link system 200. The corresponding result delivered from the second service may include link information for the second document matching the first document.

In operation 1030, the cloud-based document link system 200 may select an advertisement associated with the first document stored on the cross-clipboard by being linked with an advertisement server providing an advertisement. As an example, the cloud-based document link system 200 may select an advertisement having a degree of association with the first document above a reference threshold by analyzing content, context, and the like included in the first document. More specifically, the cloud-based document link system 200 may select an advertisement corresponding to the first document using various types of information such as a text corresponding to the first document, a keyword extracted from the first document, a document type, a source, a storage time of the first document, and the like. As another example, the cloud-based document link system 200 may select, as an advertisement linkable with the first document, an advertisement in which the first document is included in a reference advertisement display object, or an advertisement in which the second service identified to be linkable with the first document is designated as an advertisement display object.

In operation 1040, the cloud-based document link system 200 may provide the second service for the first document stored on the cross-clipboard if access to the cross-clipboard is requested through a second device. In response to a user accessing the cross-clipboard through the second device, the cloud-based document link system 200 may initially provide a list of the second service for one or more first documents along with a list of the first documents stored on the cross-clipboard. In an example, a viewer application executed in conjunction with the cloud-based document link system 200 may be installed in the second device. In response to the user requesting access to the cross-clipboard through the second device, the viewer application may deliver the request to the document link system 200, and may output, on a screen, the list of the second services and the list of the first documents provided from the document link system 200 in response to the request for access.

The cloud-based document link system 200 may apply various standards if displaying the list of the first document stored on the cross-clipboard. That is, the cloud-based document link system 200 may align the first document stored on the cross-clipboard in chronological order of being stored on the cross-clipboard, or align the first document in a descending or ascending order of second services capable of pasting and displaying the first document. The cloud-based document link system 200 may align the first document stored on the cross-clipboard in a descending or ascending order of advertisements corresponding to the first document if the advertisements are included. The cloud-based document link system 200 may align the first document stored on the cross-clipboard according to a descending or ascending order of popularity corresponding to copy requests from other users, or may classify the first document according to a type or a source of the first document, and display the first document.

Further, the cloud-based document link system 200 may provide an advertisement associated with the first document to at least one of the first device and the second device. As an example, the cloud-based document link system 200 may provide, as a pop-up advertisement, an advertisement associated with the first document using a pop-up window function of the first device. Further, the pop-up window function may be executed at a point in time when the first document requested by a user to be copied through the first device is stored on the cross-clipboard. As another example, the cloud-based document link system 200 may display an advertisement associated with the first document in one or more items included in a list of the first document if displaying, to a user, the list of the first documents according to a request for access from the user through the second device.

In operation 1050, in response to the user selecting a reference service from a list of the second services, the cloud-based document link system 200 may provide the second device with the second document associated with the second service selected by the user. More specifically, in response to the user selecting a reference service from a list, the cloud-based document link system 200 may provide the second document in the second services through being linked with the selected second service. A hyperlink recorded in a list of the second service may be set to link information provided by the second service that is identified to be capable of pasting the first document. In response to the user selecting the second service from the corresponding list, a document of the selected second service (i.e., the second document corresponding to the first document) may be provided to the second device. In an example, the cloud-based document link system 200 may display an advertisement associated with the first document if pasting the first document stored on the cross-clipboard in the second service. Further, the cloud-based document linking system 200 may past the first document in the second service at a point in time of providing the second document corresponding to the first document for the second device in the second service. Thus, the cloud-based document link system 200 may link an advertisement associated with the first document for a performance of pasting the first document, in addition to a performance of copying or viewing the first document.

As described in the foregoing, by expanding a clipboard concept of copy and paste operation with respect to a cloud infrastructure, it may be possible to store a document on a cross-clipboard and provide the document stored on the cross-clipboard through various devices at various times and locations. Further, it may be possible to link an advertisement associated with other types of services in relation with the document stored on the cross-clipboard. Thus, by applying a cloud-based cross-clipboard, it may be possible to resolve a difference in devices, times, and spaces, and a user may continue utilizing information in various environments.

Further, by linking an advertisement associated with a document stored on a cross-clipboard, it may be possible to use a cloud-based cross-clipboard as a new advertisement medium.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the well-known variety and available to those having skill in the computer software arts. Examples of computer-readable media include magnetic media such as hard disks, floppy disks, and magnetic tape; optical media such as CD ROM discs and DVD; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to exemplary embodiments of the present invention, it may be possible to accommodate a difference in services, a difference in times, and a difference in devices by expanding, to a cloud infrastructure, a copy and paste concept generally implemented in a single device. Accordingly, information in a cross-clipboard may be maintained on a cloud, and utilization of information stored on the cross-clipboard may be supported at various times, devices and/or locations.

According to exemplary embodiments of the present invention, it may possible to support a user continuously utilizing information on the Internet, through an environment that may connect services on the Internet, by automatically displaying various services linkable with a document stored on a cross-clipboard based on a cloud if retrieving the document.

A cloud-based cross-clipboard may be used as a new advertisement medium since a user copying a reference document onto a cross-clipboard may indicate an expression of a relatively strong interest in the corresponding information. Further, exposure to advertisements may be further expanded since one or more tasks performed on a cross-clipboard, such as copying, pasting, viewing, and the like may be linked with an advertisement product via various channels.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A cloud-based document linking system, comprising:
a storage unit configured to store, on a cross-clipboard, at least one first document associated with a first service that is provided through a first device if the at least one first document is requested to be copied onto the cross-clipboard;
an identification unit configured to identify at least one second service linkable with each first document stored on the cross-clipboard;
a selector configured to select at least one advertisement associated with each first document stored on the cross-clipboard; and
a providing unit configured to provide a list of each first document, and a list of the corresponding at least one second service along with the at least one selected advertisement if access to the cross-clipboard is requested through a second device.

2. The cloud-based document linking system of claim 1, wherein:
the storage unit is configured to further store at least one of a document type, a source, and a storage time of the first document, and
the source comprises at least one of a source corresponding to the first device and a source corresponding to the first service.

3. The cloud-based document linking system of claim 1, wherein the second device comprises a communication terminal that is similar to or different from the first device.

4. The cloud-based document linking system of claim 1, wherein the identification unit is configured to identify the at least one second service configured to paste and process the at least one first document.

5. The cloud-based document linking system of claim 1, wherein the selector is configured to select, using at least one of a document type, a source, and a storage time of the first document or a keyword extracted from each first document, the at least one advertisement corresponding to the at least one first document using an advertisement server.

6. The cloud-based document linking system of claim 1, wherein the selector is configured to select the at least one advertisement using an advertisement server comprising a reference advertisement display object corresponding to the at least one first document.

7. The cloud-based document linking system of claim 1, wherein the selector is configured to select the at least one advertisement using an advertisement server comprising a reference advertisement display object corresponding to the at least one second service.

8. The cloud-based document linking system of claim 1, wherein the providing unit is configured to provide the at least one advertisement corresponding to each first document in the list.

9. The cloud-based document linking system of claim 1, wherein the providing unit is configured to provide the at least one selected advertisement if storing the first document onto the cross-clipboard in response to the copy request.

10. The cloud-based document linking system of claim 1, wherein the providing unit is configured to provide the second device with a second document associated with the at least one second service in response to the at least one second service being selected from the list of the at least one second service, and to provide the at least one selected advertisement if providing the second document to the second device.

11. A method that uses a processor to provide a cloud-based document link, the method comprising:
storing, on a cross-clipboard, at least one first document associated with a first service that is provided through a first device if the at least one first document is requested to be copied onto the cross-clipboard;
identifying, using the processor, at least one second service linkable with each first document stored on the cross-clipboard;
selecting at least one advertisement associated with each first document stored on the cross-clipboard; and
providing, for a second device, a list of each first document, and a list of the corresponding at least one second service along with the at least one selected advertisement if access to the cross-clipboard is requested through the second device.

12. The cloud-based document link method of claim 11, wherein:
the storing comprises storing at least one of a document type, a source, and a storage time for each first document, and
the source comprises at least one of a source corresponding to the first device and a source corresponding to the first service.

13. The cloud-based document link method of claim 11, wherein the second device comprises a communication terminal that is similar to or different from the first device.

14. The cloud-based document link system of claim 11, wherein the identifying comprises identifying the at least one second service capable of pasting and processing the at least one first document.

15. The cloud-based document link method of claim 11, wherein the selecting comprises selecting, using at least one of a document type, a source, and a storage time of the first document or a keyword extracted from each first document, the at least one advertisement corresponding to the at least one first document using an advertisement server.

16. The cloud-based document link method of claim 11, wherein the selecting comprises selecting the at least one advertisement using an advertisement server comprising a reference advertisement display object corresponding to the at least one first document.

17. The cloud-based document link method of claim 11, wherein the selecting comprises selecting the at least one advertisement using an advertisement server comprising a reference advertisement display object corresponding to the at least one second service.

18. The cloud-based document link method of claim 11, wherein the providing comprises providing the at least one advertisement corresponding to each first document in the list.

19. The cloud-based document link method of claim 11, wherein the providing comprises providing at least one selected advertisement if storing the first document onto the cross-clipboard in response to the copy request.

20. The cloud-based document link method of claim 11, further comprising:
providing the second device with a second document associated with the at least one second service in response to the at least one second service being selected from the list of the at least one second service,
wherein the providing comprises providing the at least one selected advertisement if providing the second document to the second device.

21. A non-transitory computer-readable recording medium comprising an executable program, which when executed perform a method for controlling a cloud-based document link, the method comprising:
storing, on a cross-clipboard, at least one first document associated with a first service provided through a first device if the first document is requested to be copied onto the cross-clipboard;
identifying at least one second service linkable with each first document stored on the cross-clipboard;
selecting at least one advertisement associated with each first document stored on the cross-clipboard; and
providing, for a second device, a list of each first document, and a list of the corresponding at least one second service along with the at least one advertisement if access to the cross-clipboard is requested through the second device.
